(19) United States
(12) Patent Application Publication
(10) Pub. No.: US 2006/0095633 A1
(43) Pub. Date: May 4, 2006

(54) Data transmission coordinating method

(75) Inventors: Ruei-Ling Lin, Taipei (TW); Jiin Lai, Taipei (TW)

Correspondence Address: MADSON & AUSTIN;GATEWAY TOWER WEST, SUITE 900, 15 WEST SOUTH TEMPLE, SALT LAKE CITY, UT, 84101, US

(73) Assignee: Via Technologies, Inc.

(21) Appl. No.: 11/257,260

(22) Filed: Oct. 24, 2005

(30) Foreign Application Priority Data
Nov. 2, 2004 (TW) 093133406

(51) Int. Cl. G06F 13/36

(52) U.S. Cl. 710/306

(57) ABSTRACT

A data transmission coordinating method is used between a central processing unit and a bridge chip of a computer system. By entering the computer system into a coordinating state, the data transmission coordinating method is executed. The bridge chip and the CPU are informed of maximum bit numbers of each other for data transmission therebetween via the front side bus. Then, a commonly operable maximum bit number for data transmission between the CPU and the bridge chip can be coordinated according to the first and second maximum bit numbers. Once the commonly operable maximum bit number is determined, the CPU is reset to operate with the commonly operable maximum bit number. The maximum bit numbers are those of bus transmission bandwidth or bus transmission speed.

### FIELD OF THE INVENTION

The present invention relates to a data transmission coordinating method, and more particularly to a data transmission coordinating method for use between a central processing unit and a bridge chip of a computer system.

### BACKGROUND OF THE INVENTION

A motherboard of a computer system is generally provided with a central processing unit (CPU), a chipset and some peripheral circuits. The CPU is the core component of a computer system for processing and controlling operations and cooperation of all the other components in the computer system. The chipset may be in various forms but generally includes a north bridge chip and a south bridge chip, which are used to control communication between the CPU and the peripheral circuits. In general, the north bridge chip serves for the communication with the high-speed buses while the south bridge chip serves for the communication with low-speed devices in the system.

FIG. 1(a) is a schematic functional block diagram illustrating some devices disposed on or coupled to a motherboard 1 in a single CPU computer system. On the motherboard 1, a chipset 2 including a north bridge chip 20 and a south bridge chip 21 is electrically connected to the CPU 10 via a front side bus (FSB) 22. On the motherboard 1, an accelerated graphics port (AGP) interface 31 and a random access memory (RAM) 32 are electrically connected to the north bridge chip 20 via an AGP bus 311 and a memory bus 321, respectively. A peripheral component interconnect (PCI) interface 30 is electrically connected to the south bridge chip 21 via a PCI bus 301. In addition, an industry standard architecture (ISA) interface 40, an integrated device electronics (IDE) interface 41, a universal serial bus (USB) interface, an external keyboard device 43 and an external mouse device 44, which operate at a low speed, are electrically connected to the south bridge chip 21.

In the above architecture, the standard of the FSB 22 should support both the north bridge chip 20 and the CPU 10 coupled thereto, as illustrated in FIG. 1(b). If the transmission standard of the north bridge chip 20 via the FSB 22 mismatched that of the CPU 10, e.g. the bandwidth or bit speed in MHz thereof is different, the communication between the north bridge chip 20 and the CPU 10 would fail or some of transmitted data might be lost. For example, a bridge chip adapted to a processor with a 64-bit front-side-bus bandwidth will be unsuited to another processor with a 32-bit front-side-bus bandwidth. Otherwise, a half of the transmitted data will not be received. In other words, the compatibility between the CPU and the bridge chip is critical for data transmission. Therefore, various standards of bridge chips need be manufactured and stored for selection.

Some possible combinations of front-side-bus bandwidth of the CPU and the north bridge chip are exemplified with reference to FIGS. 2(a)˜2(d). The front side bus (FSB) includes an address bus and a data bus respectively for address and data transmission between the CPU and the north bridge chip. In the example of FIG. 2(a), the CPU 101 and the north bridge chip 201 have the same FSB bandwidth, i.e. 32 bits and 64 bits, respectively for both address and data transmission. Since the transmission standards of the CPU 101 and the north bridge chip 201 are compatible with each other, the system can operate normally. Likewise, in the example of FIG. 2(b), the CPU 102 and the north bridge chip 202 have the same FSB bandwidth, i.e. 13 bits and 32 bits, respectively for both address and data transmission. Since the transmission standards of the CPU 102 and the north bridge chip 202 are compatible with each other, the system can operate normally. In the example of FIG. 2(c), on the other hand, while the CPU 102 has 13-bit bandwidth for address transmission and 32-bit bandwidth for data transmission, the north bridge chip 201 has 32-bit bandwidth for address transmission and 64-bit bandwidth for data transmission. Since the transmission standards of the CPU 102 and the north bridge chip 201 are not consistent, the communication between the CPU 102 and the north bridge chip 201 cannot be normally performed. A similar idle situation is illustrated in FIG. 2(d), where the CPU 101 allowing 32-bit bandwidth for address transmission and 64-bit bandwidth for data transmission is inconsistent with the north bridge chip 201 allowing 13-bit bandwidth for address transmission and 32-bit bandwidth for data transmission.

With increasing tendency to compact size, personal mobile computing devices such as personal digital assistants (PDAs) or notebook computers require smaller chips and motherboards or lower pin numbers. In other words, it is preferred in one way that the integrated bridge chips and CPUs have reduced bandwidth, e.g. the example as shown in FIG. 2(b). Whereas, in a desktop computer system supporting various applications, a chip with a high pin number is preferred so that the CPU preferably has 128-bit FSB bandwidth or more. In addition to FSB bandwidth, inconsistent transmission speeds of the CPU and bridge chip also adversely affect the communication therebetween.

It is understood from the above description that depending on applications, different transmission standards of CPUs are used for pursuing the best performance or most compact effects, and thus different transmission standards of bridge chips are required to follow the transmission standards of the corresponding CPUs. It would be adversely affect the utility of material and production.

### SUMMARY OF THE INVENTION

The present invention provides a data transmission coordinating method, which is performed in advance to coordinate an operable transmission bandwidth and/or speed for both the central processing unit and the bridge chip of a computer system, thereby making the usage of the central processing unit and bridge chip flexible.

The present invention provides a data transmission coordinating method for use between a central processing unit and a bridge chip of a computer system. In the data transmission coordinating method, a first signal is issued from the central processing unit to the bridge chip to inform the bridge chip of a first transmission standard of the central processing unit, and a second signal is issued from the bridge chip to the central processing unit to inform the central processing unit of a second transmission standard of the bridge chip. A commonly operable transmission standard for both the central processing unit and the bridge chip is then coordinated according to the first and second transmission standards.

The present invention also provides a data transmission coordinating method for use between a central processing unit and a bridge chip of a computer system, including steps of: entering a coordinating state of the computer system; informing the bridge chip of a first maximum bit . number of the central processing unit for data transmission via a bus between the central processing unit and the bridge chip; informing the central processing unit of a second maximum bit number of the bridge chip for data transmission via the bus between the central processing unit and the bridge chip; coordinating a commonly operable maximum bit number for data transmission between the central processing unit and the bridge chip according to the first and second maximum bit numbers; and resetting the central processing unit to operate with the commonly operable maximum bit number. The first maximum bit number, second maximum bit number and commonly operable bit number for data transmission can be bit numbers of bus transmission bandwidth or bit numbers of bus transmission speed.

The present invention also provides a data transmission coordinating method for use between a central processing unit and a bridge chip of a computer system, comprising steps of: issuing a first reset signal; issuing a first signal of a first voltage level from the central processing unit to the bridge chip via a first pin communicating the central processing unit with the bridge chip in response to the first resetting signal, the first signal indicating a first transmission standard of the central processing unit; issuing a second signal of a second voltage level from the bridge chip to the central processing unit via a second pin communicating the bridge chip with the central processing unit in response to the first resetting signal, the second signal indicating a second transmission standard of the bridge chip; issuing a second reset signal in response to the first and second signals to reset and operate the central processing unit with a third transmission standard determined according to the first and second transmission standards. The first reset signal may be a peripheral component interconnect (PCI) reset signal, and the second reset signal may be issued by the bridge chip.

### BRIEF DESCRIPTION OF THE DRAWINGS

The above contents of the present invention will become more readily apparent to those ordinarily skilled in the art after reviewing the following detailed description and accompanying drawings, in which:

FIG. 1(a) is a schematic circuit block diagram of a computer system;

FIG. 1(b) is a schematic diagram illustrating the data transmission between the CPU and the north bridge chip via the front side bus;

FIGS. 2(a)˜2(d) are schematic diagrams illustrating four exemplified combinations of bus transmission bit-bandwidths of CPU and north bridge chip;

FIG. 3 is a schematic diagram illustrating a data transmission coordinating method according to an embodiment of the present invention, wherein the CPU and the north bridge chip issue respective coordinating signals via selected ones of pins disposed therebetween;

FIGS. 4(a)˜4(d) are time sequence plots illustrating a data transmission coordinating method according to an embodiment of the present invention;

FIGS. 5(a)˜5(d) are schematic diagrams illustrating the applications of the data transmission coordinating method of FIGS. 3 and 4(a)˜4(d) to the four exemplified combinations of FIGS. 2(a)˜2(d);

FIG. 6 is a flowchart illustrating a data transmission coordinating method according to an embodiment of the present invention;

FIG. 7 is a flowchart illustrating a data transmission coordinating method according to another embodiment of the present invention; and

FIG. 8 is a flowchart illustrating a data transmission coordinating method according to a further embodiment of the present invention.

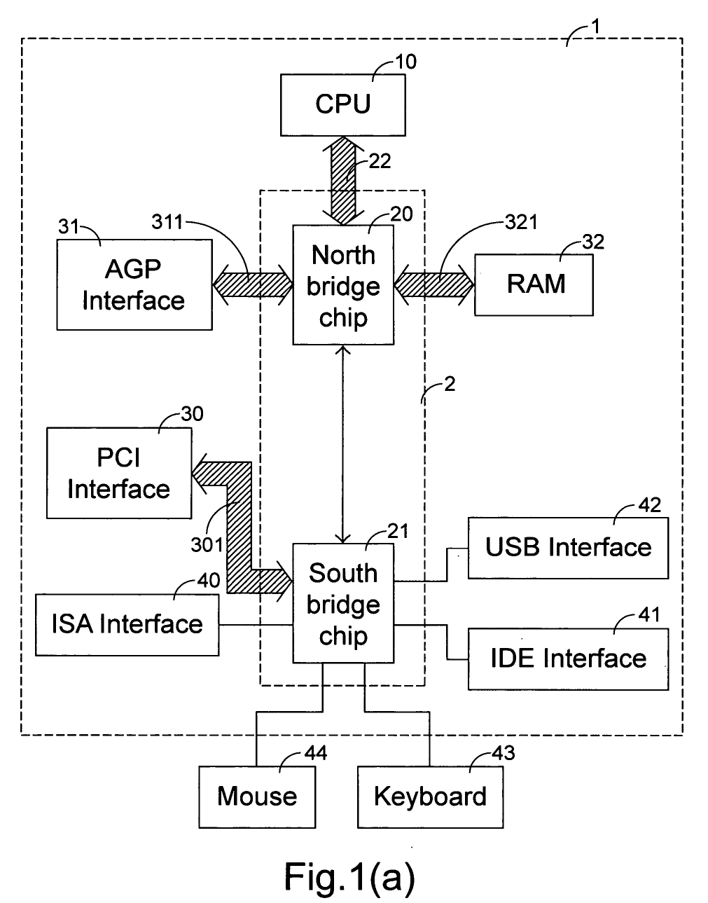

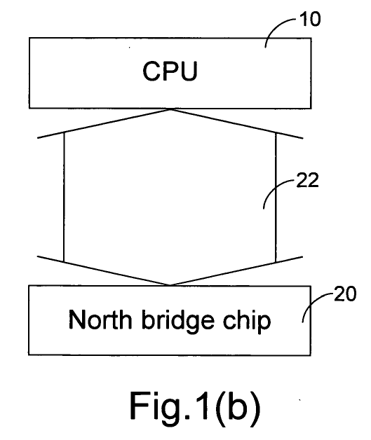

### DETAILED DESCRIPTION OF THE PREFERRED EMBODIMENT

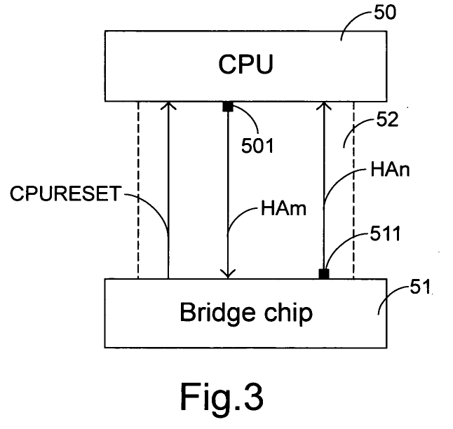

In order to enable the CPU and bridge chip with inconsistent transmission standards to communicate with each other, a data transmission coordinating method according to the present invention is performed in advance to coordinate a commonly operable transmission standard for both the central processing unit and the bridge chip of a computer system. An embodiment of the data transmission coordinating method will be illustrated herein with reference to FIG. 3.

In a computer system of FIG. 3, a CPU 50 communicates with a bridge chip 51, e.g. a north bridge chip, via a bus 52, e.g. a front side bus. For coordinating the commonly operable transmission standard, the CPU 50 issues a coordinating signal HAm from a pin 501 thereof, e.g. the mth bit, which is one of the pins in communication with the bridge chip 51, and the bridge chip 51 issues another coordinating signal HAn from a pin 511 thereof, e.g. the nth bit, which is one of the pins in communication with the CPU 50. Via the coordinating signal HAm, the bridge chip 51 is informed of the transmission standard of the CPU 50, and vice versa. On the other hand, via the coordinating signal HAn, the CPU 50 is informed of the transmission standard of the bridge chip. Since the CPU 50 and the bridge chip 51 realize the transmission standard of each other, a commonly operable transmission standard can be coordinated.

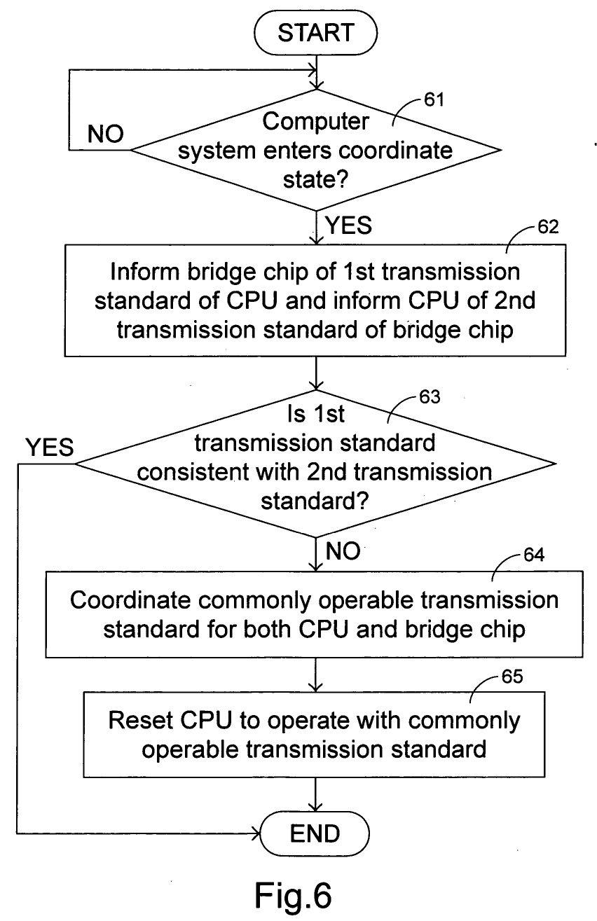

A flowchart shown in FIG. 6 illustrates a data transmission coordinating method applicable to the system of FIG. 3. For starting the data transmission coordination, a PCI reset signal is issued (Step 61). Then, the coordinating signals HAm and HAn are issued by the CPU and the bridge chip, respectively (Step 62). If the transmission standards indicated by the coordinating signals HAm and HAn are consistent with each other (Step 63), the subsequent data transmission between the CPU and bridge chip can be performed with current transmission standards. Otherwise, a commonly operable transmission standard for both the CPU and the bridge chip is coordinated (Step 64), and then the bridge chip issues a CPU reset signal to reset the CPU (Step 65). The CPU thus operates with the commonly operable transmission standard for subsequent data transmission.

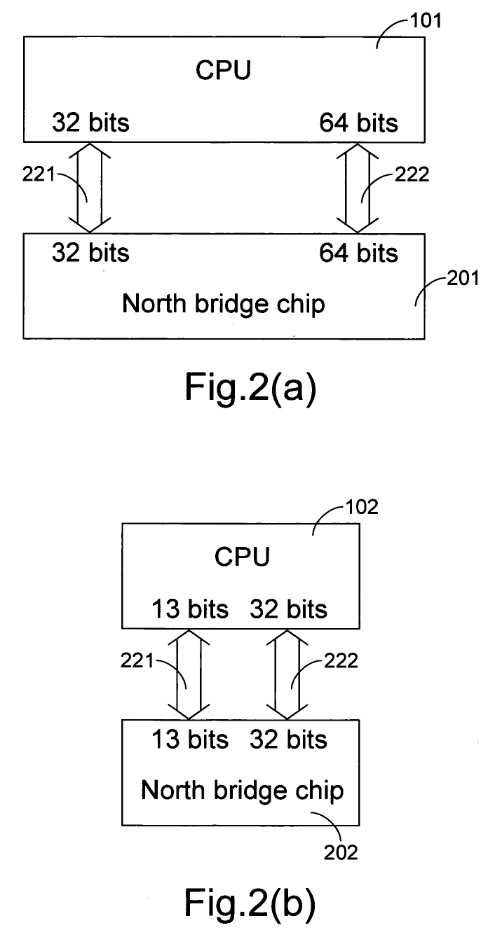

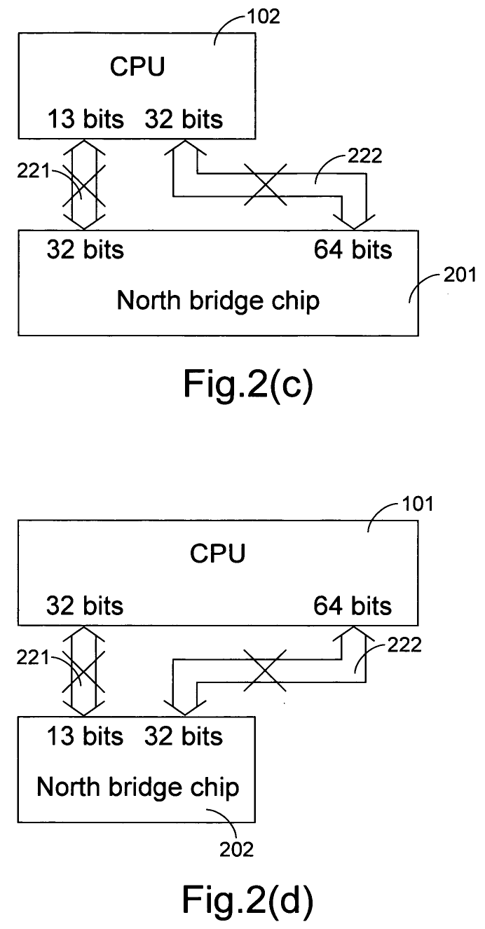

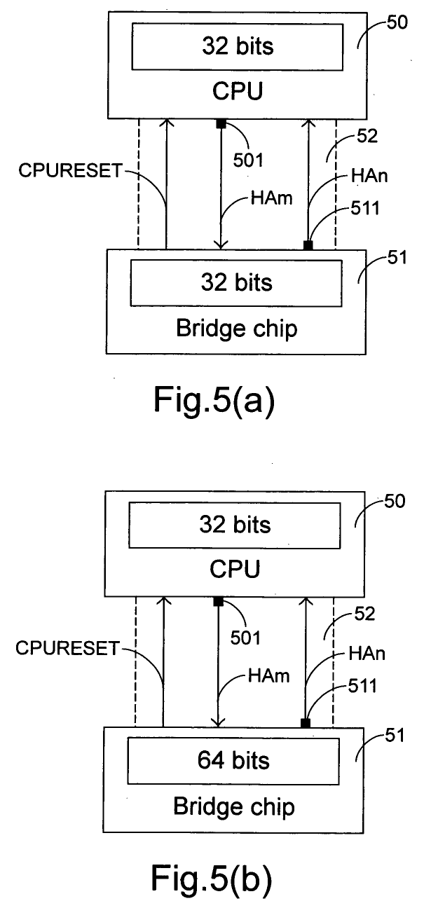

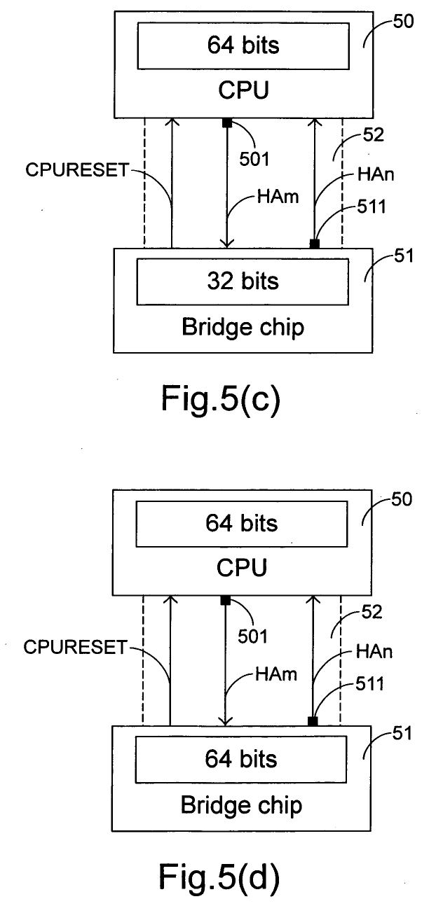

More specifically, the transmission standards are maximum bit numbers of bus transmission bandwidth or bus transmission speed. For example, when the data transmission coordinating method of FIG. 6 is applied to the combination of FIG. 2(a), the coordinating signals HAm and HAn indicate 32-bit maximum bus transmission bandwidth and 32-bit maximum bus transmission bandwidth, respectively, as shown in FIG. 5(a). The consistency of the maximum allows the successful data transmission between the CPU and the bridge chip. Likewise, as shown in FIG. 5(d), the coordinating signals HAm and HAn indicate 64-bit maximum bus transmission bandwidth and 64-bit maximum bus transmission bandwidth, respectively, which are consistent for data transmission between the CPU and the bridge chip. On the other hand, in the combinations of FIG. 5(b) or 5(c), the coordinating signals HAm and HAn indicate inconsistent 64-bit and 32-bit maximum bus transmission bandwidths. As a greater bus transmission bandwidth can support a smaller bus transmission bandwidth, the smaller one of the maximum bus transmission bandwidths, i.e. 32 bits, is suitably used as a commonly operable maximum bus transmission bandwidth for data transmission between the CPU and the bridge chip.

More specifically, the coordinating signals HAm and Han are encoded and outputted as a single bit or a serial or parallel bit combination of voltage level that differentiates the CPUs and the bridge chips, respectively. For example, when there are two choices of CPUs, e.g. 32-bit maximum bus transmission bandwidth and 64-bit maximum bus transmission bandwidth, a continuously high level and a lowered level are enough for reflecting the higher bit number and the lower bit number, which may be exchanged as well. On the other hand, bit combinations would be better for differentiating more than 2 choices of CPUs. For example, the bits “00” indicates a small bus transmission bandwidth, the bits “01” indicates a medium bus transmission bandwidth, and the bits “10” indicates a large bus transmission bandwidth.

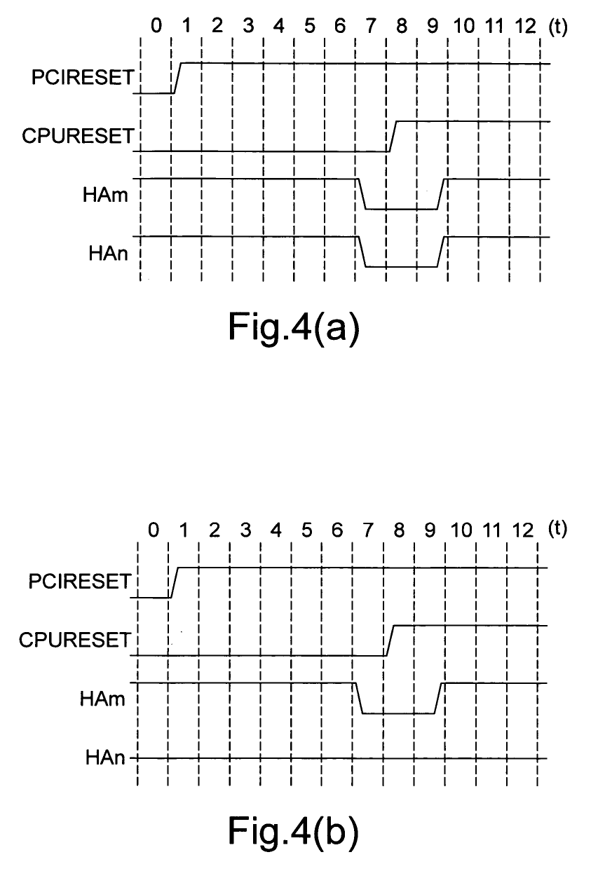

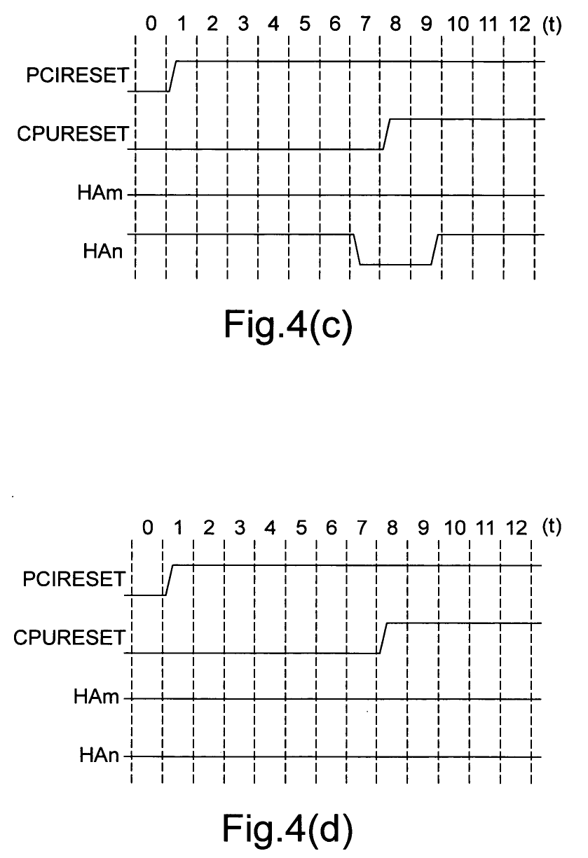

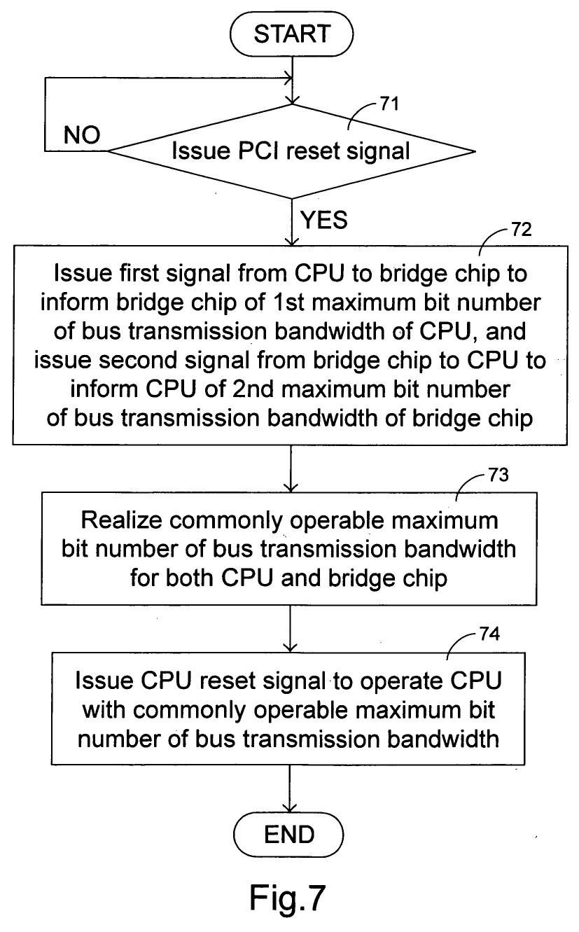

Signal-issuing time sequences of the signals involved in the present method are exemplified in FIGS. 4(a)˜4(d). As shown in FIG. 4(a), a PCI reset signal PCIRESET is first issued at t1. In response to the PCI reset signal PCIRESET, a coordinating signal HAm is outputted from the CPU to the bridge chip and another coordinating signal Han is outputted from the bridge chip to the CPU at t7. Since the coordinating signals HAm and HAn are both at the low level state, the CPU reset in response to the reset signal CPURESET issued by the bridge chip will follow, e.g. at t8, so that the CPU will operate with current transmission standard for subsequent data transmission. Likewise, in FIG. 4(d), the coordinating signals HAm and HAn are both continuously high, so the reset CPU will operate with current transmission standard for subsequent data transmission. On the contrary, in FIG. 4(b) or 4(c), one of the coordinating signals HAm and Han is continuously at the high level state and the other is at the low level state, which means the reset CPU will operate with a commonly operable transmission standard, for example the smaller maximum bit number of bus transmission bandwidth, for subsequent data transmission. The above examples are summarized in the flowchart of FIG. 7, Steps 71˜74.

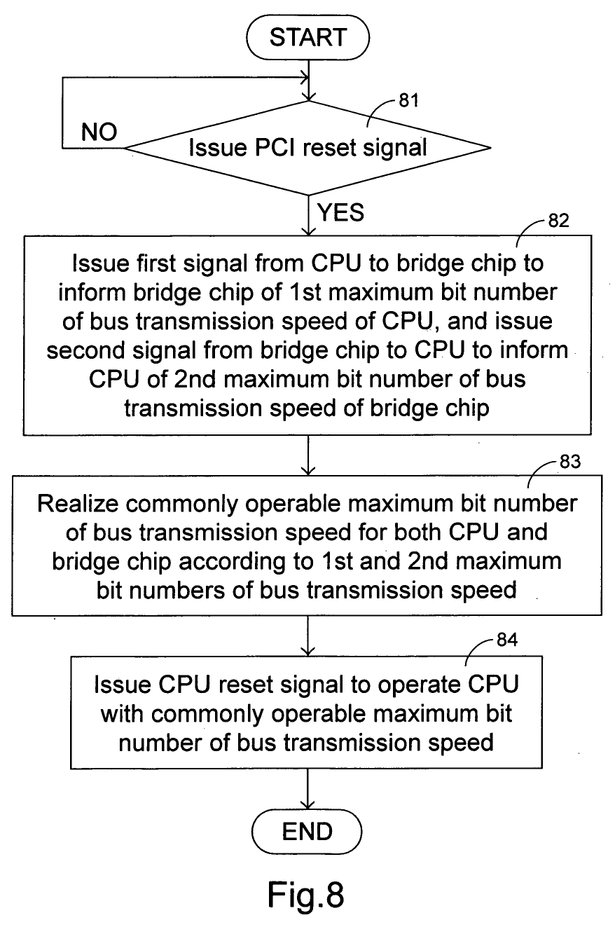

Although the above embodiments are exemplified to coordinate bus transmission bandwidth, the present invention may also be used to coordinate bus transmission speed, as described in the flowchart of FIG. 8, Steps 81˜84.

From the above embodiment, it is understood that by coordinating a commonly operable transmission standard for both the CPU and the bridge chip in advance and resetting the CPU to operate with the commonly operable transmission standard, the possible incompatibility problem between the CPU and the bridge chip can be solved so that the usage of the CPU and bridge chip becomes more flexible than ever.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A data transmission coordinating method for communication between a central processing unit and a bridge chip of a computer system, comprising steps of:
issuing a first signal from the central processing unit to the bridge chip to inform the bridge chip of a first transmission standard of the central processing unit;
issuing a second signal from the bridge chip to the central processing unit to inform the central processing unit of a second transmission standard of the bridge chip; and
coordinating a commonly operable transmission standard for both the central processing unit and the bridge chip according to the first and second transmission standards.

2. The method according to claim 1 wherein the first signal and the second signal are issued after the computer system enters a coordinating state.

3. The method according to claim 2 wherein the computer system enters the coordinating state in response to a peripheral component interconnect (PCI) reset signal.

4. The method according to claim 1 further comprising a step of resetting the central processing unit to operate with the commonly operable transmission standard in response to a resetting signal issued by the bridge chip.

5. The method according to claim 1 wherein the commonly operable transmission standard to be coordinated is a maximum bit number of bus transmission bandwidth.

6. The method according to claim 5 wherein the commonly operable transmission standard is the smaller one of a first maximum bit number of bus transmission bandwidth of the central processing unit and a second maximum bit number of bus transmission bandwidth of the bridge chip.

7. The method according to claim 1 wherein the commonly operable data transmission standard to be coordinated is a maximum bit number of bus transmission speed.

8. The method according to claim 7 wherein the commonly operable transmission standard is the smaller one of a first maximum bit number of bus transmission speed of the central processing unit and a second maximum bit number of bus transmission speed of the bridge chip.

9. The method according to claim 1 wherein the first signal is outputted by the central processing unit via a first pin communicating the central processing unit with the bridge chip.

10. The method according to claim 9 wherein the second signal is outputted by the bridge chip via a second pin communicating the bridge chip with the central processing unit.

11. The method according to claim 10 wherein the same level states of the first signal and the second signal indicate the same transmission standards, and different level states of the first signal and the second signal indicate different transmission standards.

12. The method according to claim 10 wherein the same bit combinations of the first signal and second signal indicate the same transmission standards, and different bit combinations of the first and second signals indicate different transmission standards.

13. A data transmission coordinating method for communication between a central processing unit and a bridge chip of a computer system, comprising steps of:
entering a coordinating state of the computer system;
informing the bridge chip of a first maximum bit number of the central processing unit for data transmission via a bus between the central processing unit and the bridge chip;
informing the central processing unit of a second maximum bit number of the bridge chip for data transmission via the bus between the central processing unit and the bridge chip;
coordinating a commonly operable maximum bit number for data transmission between the central processing unit and the bridge chip according to the first and second maximum bit numbers; and
resetting the central processing unit to operate with the commonly operable maximum bit number.

14. The method according to claim 13 wherein the computer system enters the coordinating state in response to a peripheral component interconnect (PCI) reset signal.

15. The method according to claim 13 wherein the first maximum bit number, second maximum bit number and commonly operable bit number for data transmission are bit numbers of bus transmission bandwidth.

16. The method according to claim 13 wherein the first maximum bit number, second maximum bit number and commonly operable bit number for data transmission are bit numbers of bus transmission speed.

17. A data transmission coordinating method for communication between a central processing unit and a bridge chip of a computer system, comprising steps of:
issuing a first reset signal;
issuing a first signal of a first voltage level from the central processing unit to the bridge chip from one of the pins in communication with the bridge chip in response to the first resetting signal, the first signal indicating a first transmission standard of the central processing unit;
issuing a second signal of a second voltage level from the bridge chip to the central processing unit from one of the pins in communication with the bridge chip in response to the first resetting signal, the second signal indicating a second transmission standard of the bridge chip;
issuing a second reset signal in response to the first signal and the second signal to reset and operate the central processing unit with a third transmission standard determined according to the first and second transmission standards.

18. The method according to claim 17 wherein the first reset signal is a peripheral component interconnect (PCI) reset signal.

19. The method according to claim 17 wherein the first, second and third transmission standards are maximum bit numbers of bus transmission bandwidth or bus transmission speed for data transmission between the central processing unit and bridge chip.

20. The method according to claim 17 wherein the second reset signal is issued by the bridge chip.
